(19) United States
(12) Patent Application Publication
(10) Pub. No.: US 2012/0141717 A1
(43) Pub. Date: Jun. 7, 2012

(54) DECORATIVE PANEL ASSEMBLIES AND ASSOCIATED METHODS

(76) Inventor: Chad Alexander Overton, Thousand Oaks, CA (US)

(21) Appl. No.: 13/311,096

(22) Filed: Dec. 5, 2011

Related U.S. Application Data
(60) Provisional application No. 61/419,299, filed on Dec. 3, 2010.

(51) Int. Cl. B32B 3/06; B32B 38/10; B32B 37/12; B23P 17/00

(52) U.S. Cl. 428/57; 29/407.1; 156/247

(57) ABSTRACT

Decorative panel assemblies and associated methods for forming and installing decorative panel assemblies are provided. One or more decorative panels may be provided, and each panel may include a front surface forming one or more decorative surfaces and a back surface including an at least partially flat surface area for abutting a flat surface to which the decorative panel is applied. Additionally, as desired, a template may be provided for applying the one or more decorative panels to the flat surface, the template sized based at least in part upon the size of the one or more decorative panels.

### TECHNICAL FIELD

Embodiments described herein relate generally to decorative panels and associated methods for forming and installing decorative panels.

### BACKGROUND

Paneling and other raised features are popular ornamentation to a home's doors and walls. Currently, in order to upgrade from non-paneled doors (or flat doors) to paneled doors, one must either replace the door itself or replace the whole door unit with a pre-hung door on, an included door frame. Replacing the door itself typically requires specialty tools and skills to route the hinge locations and bore the door handle and latch holes, along with careful measuring and/or the use of a jig. Using a pre-bored door eliminates the routing and boring if the components happen to line up with the hardware locations on the existing frame. Often times, however, this is not the case. Replacing a door with pre-hung door assemblies is relatively messy and time consuming, as it requires demolition of the existing door, frame, and surrounding moldings, and then replacing the same. Materials cost as well as labor costs also impact a decision whether or not to upgrade an existing door. For example, a pre-hung hollow core door may cost approximately two times the amount of a hollow door. A raised panel door may be approximately four times the cost of a simple hollow door with a pre-hung version adding another substantial cost. In addition to the door and/or door and frame assemblies, handles, latches, moldings, finishing materials, and labor also incur substantial costs.

Likewise, wall paneling and the installation thereof can be relatively labor intensive. Wall paneling typically requires relatively significant amounts of measuring, calculating, aligning, re-aligning, and finishing. Each design, such as square or rectangular designs, typically require exact cutting of moldings for each side and exact perpendicular alignment of the four side pieces with one another, plus alignment and spacing of the assembled sections. Corner joints then need to be filled/caulked on each finished assembly. Given the finishing required on each assembled section, the moldings cannot be painted prior to installation, meaning that detailed painting has to be performed after installation.

Accordingly, there is an opportunity for improved decorative panel assemblies and associated systems and methods that minimize time, effort, labor, and costs associated with upgrading a home interior or exterior with paneling.

### BRIEF DESCRIPTION OF THE DRAWINGS

FIGS. 1A-1C illustrate example panel arrangements applied to doors, in accordance with example embodiments.

FIGS. 2A-2B illustrate example panel arrangements applied to walls or other flat surfaces, in accordance with example embodiments.

FIG. 3A illustrates a back view of a raised panel, in accordance with an example embodiment.

FIG. 3B illustrates a cross-section view of a raised panel, in accordance with an example embodiment.

FIG. 4A illustrates a back view of a framed panel, in accordance with an example embodiment.

FIG. 4B illustrates a cross-section view of a framed panel, in accordance with an example embodiment.

FIG. 5 illustrates a side view of a panel, in accordance with an example embodiment.

FIGS. 6A-6E illustrate example techniques for applying panels, in accordance with example embodiments.

FIGS. 7A-7C illustrate example templates for use when applying panels, in accordance with example embodiments.

FIG. 8 is a flow chart of an example method for applying panels to a surface, according to an example embodiment.

### DETAILED DESCRIPTION OF EXAMPLE EMBODIMENTS

Embodiments of the disclosure now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments described herein provide decorative panel assemblies, and associated apparatus, systems, and methods. The decorative panel assemblies may be installed on any flat surface associated with a home or other structure, such as a door, wall, ceiling, or furniture, to simulate a raised decorative panel. For example, in one embodiment, one or more decorative panels may be affixed to a flat-faced door to simulate a door having raised panels. In another embodiment, one or more decorative panels may be affixed to a portion of a wall (e.g., lower portion) to simulate wall paneling type decor. In other embodiments, one or more decorative panels may be affixed to a ceiling, such as to simulate a ceiling tray or other ceiling molding. In yet other embodiments, one or more decorative panels may be affixed to a furniture surface to simulate decorative accents. According to various embodiments, multiple panels can be aligned vertically and/or horizontally, such as in a predetermined arrangement to achieve the desired effect of simulating more ornate and decorative items while minimizing cost and/or effort to replace existing items.

As mentioned above, specialty tools, demolition mess, door sizing, hinge location, handle/latch alignment with a strike plate, wall panel placement, finishing, and extended labor time are all significantly reduced or eliminated by these pre-manufactured panels. The panel assemblies described according to various embodiments herein can be installed in a matter of minutes and installed by an unskilled person.

These and other advantages will become apparent in light of the detailed example embodiments of the disclosure, which are described below with reference to the drawings.

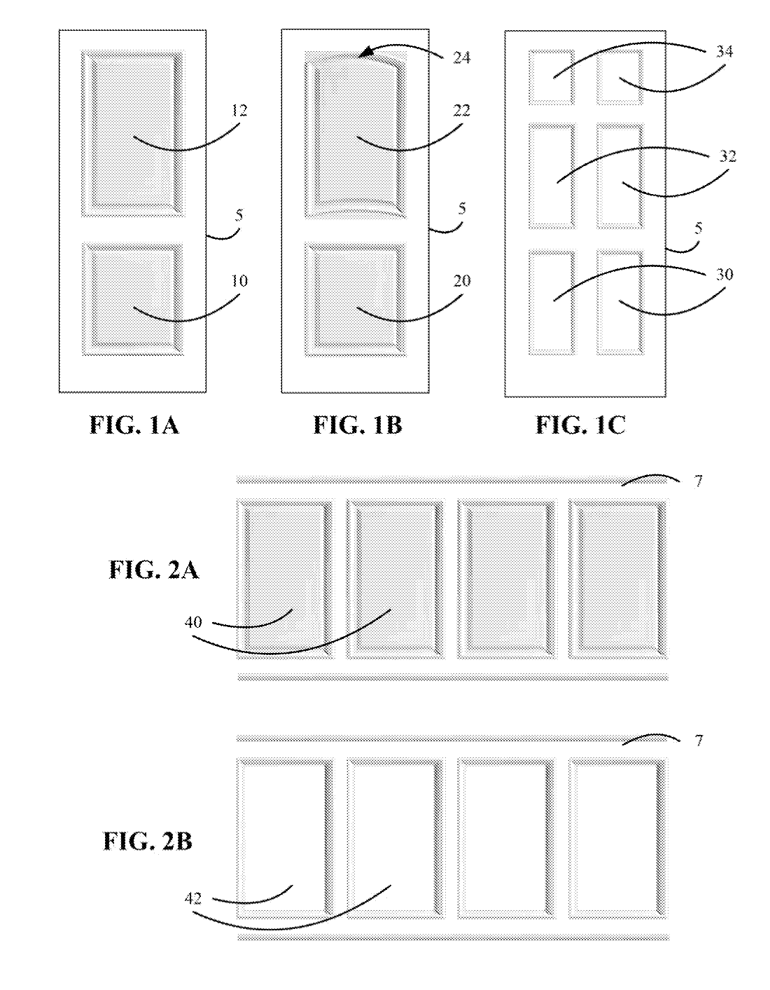

FIGS. 1A-1C illustrate example embodiments of panel assemblies arranged and affixed to a flat surface of a door 5. According to the embodiment shown in FIG. 1A, two panels 10, 12 are affixed to a surface of a door 5, such as a front or back surface of the door 5. In this embodiment, a lower panel 10 may be sized differently than an upper panel 12. The lower panel 10 may be smaller or larger than the upper panel 12. Moreover, the embodiment illustrated in FIG. 1A shows each of the two panels 10, 12 being a squared, raised panel. In certain embodiments, each squared, raised door panel (and wall panel, as described below with reference to FIG. 2A) can be formed as a single element having four sides, a front, and a back, and generally forming a rectangle. The panels 10, 12 may have various dimensions, which may be determined in part by the size and shape of the door 5 on which the panels 10, 12 are to be affixed, as described by example in more detail below. The panels may be affixed to a door 5 according to any number of suitable techniques, as described by example in more detail below.

The embodiment illustrated in FIG. 1B is similar to that described with reference to FIG. 1A except that at least one of the panels has an arched edge. According to this embodiment, two raised panels 20, 22 are affixed to a door 5, with an upper panel 22 having an arched edge 24. In other embodiments, more than one edge may have an arch. Moreover, in other embodiments, each panel may include at least one arched edge.

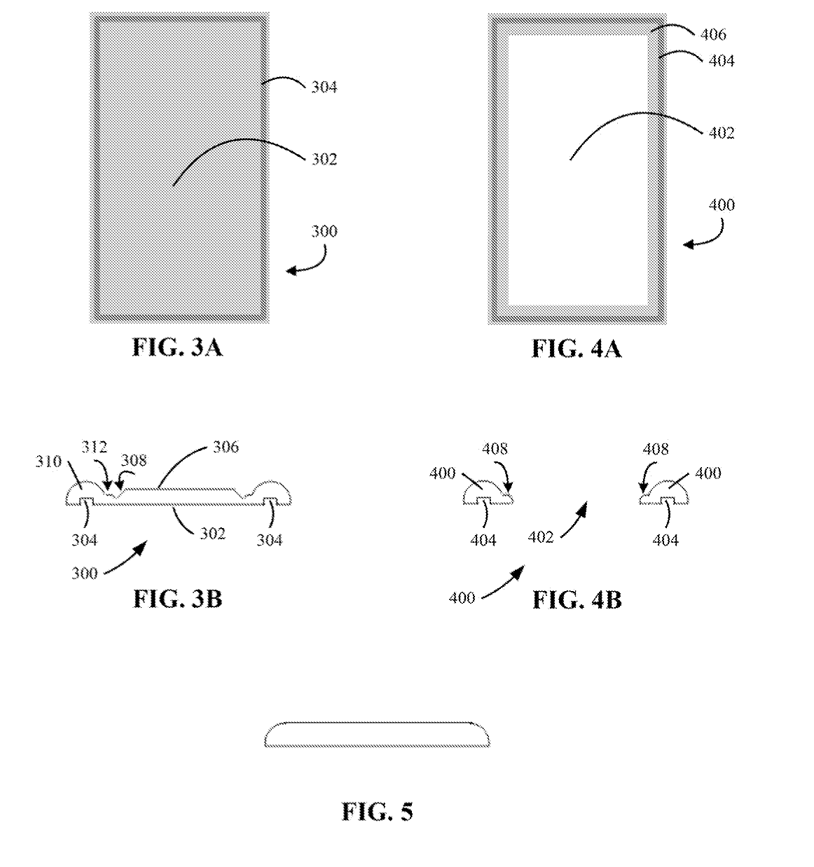

The embodiment illustrated in FIG. 1C includes six panels: two lower panels 30, two middle panels 32, and two upper panels 34, arranged in two vertical rows of three. Each of the illustrated panels is a frame panel having a void defined between a raised frame of each panel, which would expose the surface of the door 5 therethrough. The differences between raised panels and framed panels are provided in more detail with reference to FIGS. 3A-4B. Each of the panels 30, 32, 34 may have the same or different dimensions. For example, as shown, the upper panels 34 may be smaller in height than the middle panels 32 or the lower panels 30.

According to one embodiment, each of the panels 10, 12, 20, 22 for the doors having two panel arrangements may be formed with relative dimensions ranging between approximately 15.5 inches and approximately 24 inches in width and approximately 24 inches and approximately 36 inches in height. In one embodiment, each of the panels 30, 32, 34 for the doors having six panel arrangements may be formed with relative dimensions ranging between approximately 6 inches and approximately 12 inches in width and approximately 4 inches and approximately 9 inches in height. It is appreciated, however, that the aforementioned dimensions are provided for illustrative purposes and are not intended to be limiting. The dimensions may therefore vary depending upon the number and arrangement of the panels, and size of the door on which they are intended to be affixed.

It is appreciated that the door panel embodiments shown in FIGS. 1A-1C are provided for illustrative purposes and that many variations may exist. For example, any combination and number of panels may be arranged on a door. Similarly, any size of panels may be arranged in any manner. In addition, while squared panels and arched panels are illustrated, in other embodiments, the panels may be formed according to any desired geometry. Similarly, panels shown in the above embodiments as raised may instead be open framed panels and panels shown as framed panels may instead be raised panels.

FIGS. 2A-2B illustrate embodiments in which decorative panel assemblies are applied to a wall 7. According to the embodiment illustrated in FIG. 2A, a series of raised panels 40, similar to those described with reference to FIGS. 1A-1B, are affixed to a wall 7. The panels 40 may be affixed along any portion of the wall, such as within a lower portion, along the middle (e.g., acting as a chair rail, etc.), along or near the bottom edge or top edge (e.g., enhancing the molding of the wall, etc.). FIG. 2B illustrates an embodiment in which the panels 42 are framed panels having an open interior or void defined therethrough.

According to one embodiment, the raised panels 40 and/or the framed panels 42 may be formed with relative dimensions ranging between approximately 12 inches and approximately 36 inches in width and approximately 20 inches and approximately 26 inches in height, such as if applied to the lower portion of the wall to simulate decorative paneling. It is appreciated, however, that the aforementioned dimensions are provided for illustrative purposes and are not intended to be limiting. The dimensions may therefore vary depending upon the number and arrangement of the panels, and size of the wall portion on which they are intended to be affixed. Moreover, any other panel configuration and shape may be provided for affixing to a wall surface, and are not limited to those illustrated by FIGS. 2A-2B.

FIGS. 3A-3B illustrate a back view and cross-section view of a raised panel, respectively, such as any of the panels 10, 12, 20, 22, 40 described above, according to one embodiment. A raised panel 300 may include a flat surface 302 and a recessed groove or valley 304 formed along at least a portion of the backside of the panel 300 near, but slightly distanced from, the periphery or edge of the panel 300. The groove or valley 304 allows adhesive to be applied or included with the panel 300, while still allowing the flat surface 302 to, be flush with the flat surface, of the door, wall, or other surface to which the panel is to be applied. With reference to FIG. 3B, each panel can be constructed to form a raised center section 306 with tapered edges 308 and an integral thicker outer molding 310 with tapered inner edges 312. The tapered edges 308, 312 meet to form a valley or concave section of the panel, providing a decorative and raised effect. It is appreciated that a raised panel 300 may be formed with any geometry as desired and is not limited to that shown in FIGS. 3A-3B. Additionally, a groove or valley may or may not be provided. As desired, other attachment mechanisms may be utilized to affix a panel 300 to a door, wall, or other surface.

According to some embodiments, the panel 300 may be manufactured as a single pre-shaped molded piece. For example, the panel may be molded from materials including, but not limited to, plastic, urethane, wood composite, wood, rubber, any other suitable manufactured and/or moldable materials, and/or any combinations of materials as desired. Examples of techniques for manufacturing the panel, include, but are not limited to, a plastic or urethane molding process or a medium density fiberboard (“MDF”) or high density fiberboard (“HDF”) pressure forming process. In other embodiments, however, each panel 300 may not be molded but instead manufactured, such as through conventional shaping and planing techniques applied to woods or polymers, or other materials.

FIGS. 4A-4B illustrate a back view and cross-section view of a framed panel, respectively, such as any of the panels 30, 32, 34, 42 described above, according to one embodiment. A framed panel 400 may similarly include an outer molding 406 having a groove or valley 404 formed along at least a portion of the backside of the panel 400 near, but at slightly distanced from, the periphery or edge of the panel 400. However, the inner edges 408 may define a void or opening 402, forming a picture frame effect. An opening 402 may be desired to show a surface of the door or wall underneath (or any other surface to which the framed panel 400 may be applied). It is appreciated that a framed panel 400 may be formed with any geometry as desired and is not limited to that shown in FIGS. 4A-4B. Additionally, a groove or valley may or may not be provided. As desired, other attachment mechanisms may be utilized to affix a panel 300 to a door, wall, or other surface.

FIG. 5 illustrates an example side view of a panel, which may be a raised panel or a framed panel. With reference to FIG. 5, once a panel is applied to a door, wall, or other surface, at least a portion of the panel may extend outwardly from the surface, thereby forming a decorative feature.

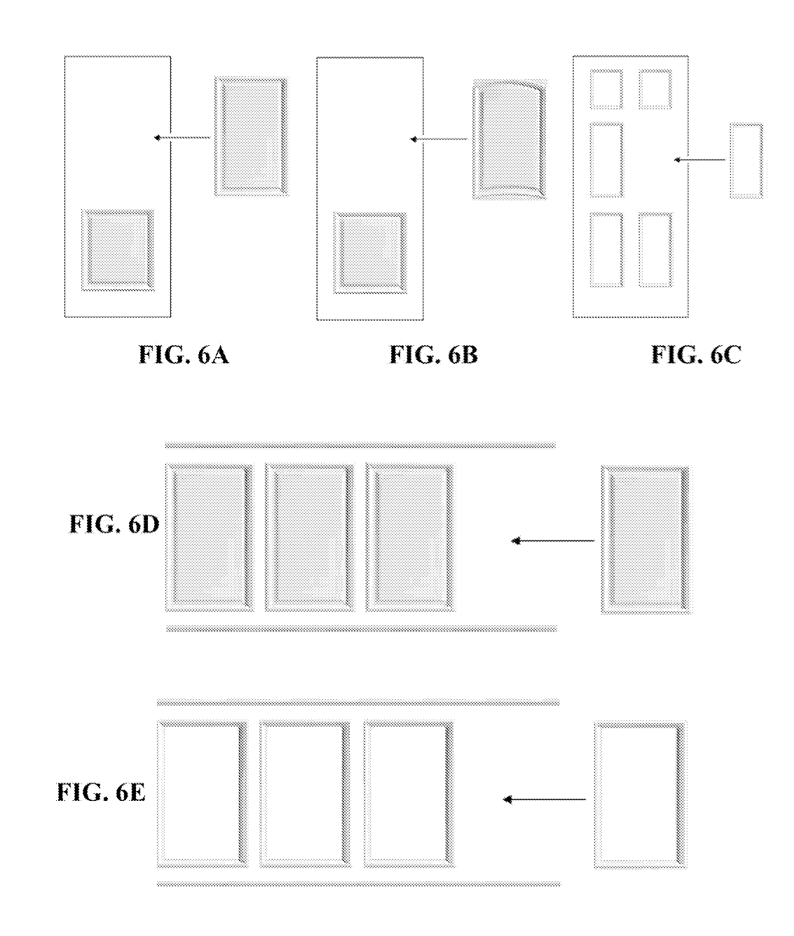

As desired in various embodiments, each panel can be secured to a respective flat surface (e.g., door, wall, ceiling, furniture, etc.) using a variety of adhesive materials, such as, but not limited to, glue, construction glue, tape, hook and loop closures, or using hardware, such as, but not limited to, nails, staples, or screws. According to one embodiment, panels may be provided in a self-adhering configuration, which includes pre-installed or applied adhesive material. In some embodiments, the pre-installed or applied adhesive material may be provided within the groove or valley defined near the edge on the back surface of the panel, such as is described with reference to FIGS. 3A-4B. In other embodiments, the pre-installed or applied adhesive material may be provided on one or more areas of the flat back surface, such as near the edges and/or near the center. FIGS. 6A-6E illustrate example techniques for applying one or more panels to a flat surface, using the panel arrangements shown in FIGS. 1A-2B, respectively, as example arrangements.

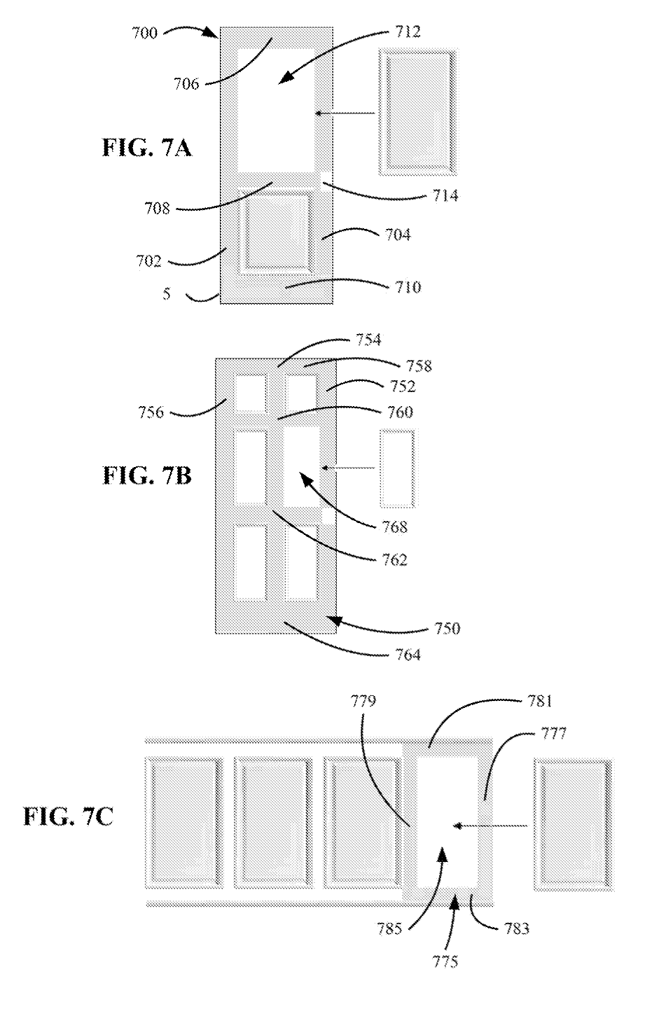

According to various embodiments, for ease of installation and accuracy, panel assemblies may optionally include a self-adhering paper installation template. The template may include a pre-installed adhesive material on both sides to allow the template to be reversed for use on the front and back sides of a door or other surface. In some embodiments, the templates are specific to each door size and each panel style. For example, as illustrated in FIG. 7A, a template 700 for a two panel arrangement includes two vertical sections—a first vertical section 702 oriented along the hinged side and a second vertical section 704 oriented along the latch side of the door 5. The template 700 may further include three horizontal sections—a first horizontal section 706 along the top, a second horizontal section 708 along the middle, and a third horizontal section 710 along the bottom of the door 5. These horizontal sections and vertical sections define an area 712 where a panel is to be applied, such as is illustrated by FIG. 7A. In one embodiment, a template 700 may further include a cut-out 714 or other allowance for the door handle on the latch side of the template 700. In certain embodiments, the cut-out 714 may be removed once the template 700 is affixed to a flat surface. For example, the cut-out 714 may not include adhesive material such that the cut-out 714 can be removed.

FIG. 7B illustrates another template 750, according to one embodiment for use with a six panel arrangement. Different than the template 700 for a two panel arrangement, this template 750 will include three vertical sections 752, 754, 756, and four horizontal sections 758, 760, 762, 764, defining six areas 768 where panels are to be applied.

FIG. 7C illustrates another template 775 for a panel arrangement to be applied to a wall (or other flat surface), according to one embodiment. In this embodiment, the template 775 includes two vertical sections 777, 779 and two horizontal sections 781, 783, defining an area 785 where a panel is to be placed. According to one embodiment, the vertical sections 777, 770 and the horizontal sections 781, 783 can be scaled in order to be cut the desired width and height, depending on the orientation of the panel, the length of the wall, and the height of the chair rail (or other desired placement). It is appreciated that, in some embodiments, a template may include multiple sections similar to the template 775 to allow precisely aligning and applying multiple panels to a flat surface (similar to that illustrated and described with reference to the door templates in FIGS. 7A-7B).

In use, a user would open a package, remove the panels and the template and apply the template to the door, wall, ceiling, furniture, or other flat surface. The user may then peel and remove paper covering a pre-installed adhesive material from the back of the panel (or attach with nails or other hardware if desired), and apply the panels to the door or wall surface in the areas identified by the template. The user could then caulk the edges of the panels (and fill nail or other hardware holes—if applicable), or paint the panels as-is.

It is appreciated that, in other embodiments, templates may be provided that are multi-purposed, such as having multiple outlines, perforations, or other scales that would allow applying to different doors or wall sizes and/or applying different panel arrangements. Thus, in embodiments including multi-purposed templates, a kit may be provided together or in parts that includes a single multi-purposed template (or a select few multi-purposed templates) and any number, shape, or size of templates, which may be selected individually, to allow varied applications. It is appreciated, however, that in other embodiments, different templates and panels may be provided for specific applications, such as, but not limited to, the above examples, which may increase the ease of installation and minimize any additional effort required by the installer.

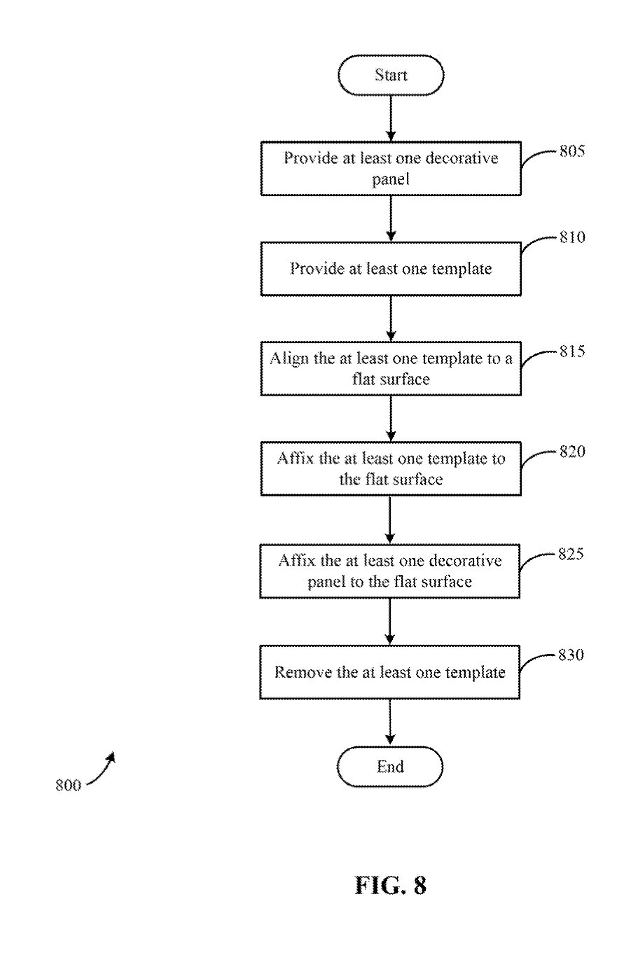

FIG. 8 is a flow chart of an example method 800 for applying one or more panels to a surface, according to an example embodiment. The method 800 may begin at block 805, and any number of decorative panels may be provided. As described above, each of the decorative panels may be formed from a wide variety of materials and include any number of suitable dimensions. At block 810, at least one template may be provided. The template may assist in aligning the one or more decorative panels on the surface to which the panels will be applied or affixed.

At block 815, the at least one template may be aligned to surface to which the panels will be applied. At block 820, the at least one template may be affixed (e.g., temporarily affixed to the surface. As desired, one or more cut-out portions may be removed from the at least one template in order to define areas or section of the surface to which the panels will be affixed. At block 825, the one or more decorative panels may be affixed to the surface utilizing any number of suitable attachment techniques, such as adhesive materials and/or attachment hardware. The at least one template may then be removed at block 830, and the method 800 may end. As desired, the decorative panels may be caulked, stained, and/or painted either prior to removal of the at least one template or subsequent to removal of the at least one template.

Marty modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A decorative panel, comprising:
a front surface forming one or more decorative surfaces;
a back surface including an at least partially flat surface area for abutting a flat surface to which the decorative panel is applied;
a recessed groove defined along at least a portion of the back surface and proximate at least one edge of the panel; and
adhesive deposited within the recessed groove for adhering to a flat surface to which the decorative panel is to be applied.

2. The decorative panel of claim 1, wherein the decorative panel is a raised panel.

3. The decorative panel of claim 1, wherein the decorative panel is a framed panel defining a void between edges of the decorative panel.

4. The decorative panel of claim 1, wherein the decorative panel includes an arched edge.

5. The decorative panel of claim 1, wherein a template is provide for applying the decorative panel to the flat surface, the template sized based at least in part upon the size of the decorative panel, and
wherein the template is alignable at least partially with an intended surface to which the plurality of panels are to be applied, and wherein the template designates an area for applying each of the plurality of panels.

6. The decorative panel of claim 1, wherein the decorative panel is formed from at least one of (i) plastic, (ii) urethane, (iii) wood composite, (iv) wood, or (v) rubber.

7. The decorative panel of claim 1, wherein the decorative panel is formed utilizing at least one of (i) a plastic molding process, (ii) a urethane molding process, or (iii) a medium density fiberboard forming process, or (iv) a high density fiberboard forming process.

8. A system of decorative panels, the system comprising:
a plurality of panels; and
a template sized according to the plurality of panels and a dimension of an intended surface to which the plurality of panels are to be applied, wherein the template is alignable at least partially with an intended surface to which the plurality of panels are to be applied, and wherein the template designates an area for applying each of the plurality of panels.

9. The system of claim 8, wherein the plurality of panels comprises two panels.

10. The system of claim 8, wherein the plurality of panels comprises six panels.

11. The system of claim 8, wherein the plurality of panels comprises greater than six panels.

12. The system of claim 8, wherein each of the panels comprises:
a front surface forming one or more decorative surfaces; and
a back surface including an at least partially flat surface area for abutting the intended surface to which the panel is applied.

13. The system of claim 12, wherein each of the panels further comprises:
a recessed groove defined along at least a portion of the back surface and proximate at least one edge of the panel; and
adhesive deposited within the recessed groove for adhering to the intended surface to which the panel is applied.

14. The system of claim 8, wherein each of the panels comprises one of (i) a raised panel or (ii) a framed panel defining a void between edges of the panel.

15. The system of claim 8, wherein at least one of the plurality of panels comprises an arched edge.

16. A method for applying one or more decorative panels to a flat surface, the method comprising:
providing at least one decorative panel;
providing at least one template;
aligning the at least one template with a flat surface to which the at least one decorative panel is to be applied;
affixing the at least one template to the flat surface;
affixing the at least one decorative panel to the flat surface by aligning the at least one decorative panel to an area designated by the at least one template; and
removing the at least one template from the flat surface.

17. The method of claim 16, wherein affixing the at least one decorative panel includes engaging an adhesive supplied within a groove on a back surface of the at least one panel to the flat surface.

18. The method of claim 17, wherein providing at least one decorative panel comprises providing a plurality of decorative panels.

19. The method of claim 17, wherein providing at least one decorative panel comprises providing: one of (i) a raised panel or (ii) a framed panel defining a void between edges of the panel.
